(19) United States
(12) Patent Application Publication
(10) Pub. No.: US 2009/0050448 A1
(43) Pub. Date: Feb. 26, 2009

(54) METHOD AND APPARATUS FOR ADJUSTING PITCH OF BUFFER TRAY IN TEST HANDLER HAVING RACK AND PINION MEANS

(76) Inventor: Jin-Hwan Lee, Cheonan-si (KR)

Correspondence Address: DALY, CROWLEY, MOFFORD & DURKEE, LLP, SUITE 301A, 354A TURNPIKE STREET, CANTON, MA, 02021-2714, US

(21) Appl. No.: 11/869,161

(22) Filed: Oct. 9, 2007

(30) Foreign Application Priority Data
Aug. 22, 2007 (KR) 10-2007-0084341

(51) Int. Cl. B65G 47/24; B65G 19/00; B65G 25/00

(52) U.S. Cl. 198/717

(57) ABSTRACT

In a method and an apparatus for adjusting a pitch of a buffer tray for receiving semiconductor devices, the buffer tray includes a plurality of pairs of unit buffer trays to receive the semiconductor devices. A first pitch between the pairs of unit buffer trays is adjusted by a first driving section. A second pitch between first unit buffer trays and second unit buffer trays in the pairs is adjusted by a second driving section. The semiconductor devices are transferred between a test tray and a customer tray via the buffer tray having the adjusted pitch in a test handler. Accordingly, the time required to transfer the semiconductor devices may be shortened.

### CROSS-REFERENCE TO RELATED APPLICATIONS

This application claims priority under 35 USC §119 to Korean Patent Application No. 2007-84341, filed on Aug. 22, 2007 in the Korean Intellectual Property Office (KIPO), the contents of which are incorporated herein by reference in their entirety.

### BACKGROUND OF THE INVENTION

1. Field of the Invention

The present invention relates to an apparatus for testing semiconductor devices. More particularly, the present invention relates to a buffer tray for receiving semiconductor devices in a test handler used for testing the semiconductor devices.

2. Description of the Related Art

Generally, semiconductor devices, such as volatile or non-volatile memory devices, system large-scale integration (LSI) devices, etc., are shipped after testing operating characteristics of the semiconductor devices.

A test handler transfers semiconductor devices into a test chamber to test the semiconductor devices. Particularly, semiconductor devices are transferred from a customer tray to a test tray via a buffer tray. Further, semiconductor devices that have been tested in the test chamber are transferred from a test tray to a customer tray via a buffer tray.

The test handler includes a picker system for transferring the semiconductor devices between the test tray and the customer tray. Examples of the picker system are disclosed in U.S. Pat. Nos. 6,761,526, 7,000,648, 7,023,197, etc.

Recently, to shorten the time required to transfer semiconductor devices, the picker system employs a plurality of pickers. Further, the picker system employs a pitch-adjusting device to equalize a pitch between the pickers with those of the test tray and the customer tray. However, shortening the time required to transfer the semiconductor devices has limitations because the weight of the pitch-adjusting device is increased as the number of the pickers is increased.

### SUMMARY OF THE INVENTION

Example embodiments of the present invention provide a method of adjusting a pitch of a buffer tray to improve a transfer speed of semiconductor devices in a test handler used for testing the semiconductor devices.

Further, example embodiments of the present invention provide an apparatus for adjusting a pitch of a buffer tray to improve a transfer speed of semiconductor devices in a test handler used for testing the semiconductor devices.

In a method of adjusting a pitch of a buffer tray according to an aspect of the present invention, the buffer tray may include a plurality of pairs of unit buffer trays for receiving semiconductor devices. The pitch of the buffer tray may be adjusted by adjusting a first pitch between the pairs of unit buffer trays, and adjusting a second pitch between first unit buffer trays and second unit buffer trays in the pairs.

In some example embodiments of the present invention, the first pitch may be adjusted by moving at least one first pair and at least one second pair of the unit buffer trays in opposite directions to each other. The first and second pairs may each be disposed on both sides with respect to a central point of the buffer tray.

In some example embodiments of the present invention, the first pitch may be adjusted by moving at least one first pair and at least one second pair of unit buffer trays in opposite directions to each other. The first and the second pairs may each be disposed on both sides with respect to a pair of unit buffer trays adjacent to a central point of the buffer tray.

In some example embodiments of the present invention, the first pitch may be adjusted by moving at least one remaining pair of unit buffer trays, except for an outermost pair of unit buffer trays, in a pitch direction of the buffer tray.

In some example embodiments of the present invention, the second pitch may be adjusted by relatively moving the second unit buffer trays with respect to the first unit buffer trays.

In an apparatus for adjusting a pitch of a buffer tray according to another aspect of the present invention, the buffer tray may include a plurality of pairs of unit buffer trays for receiving semiconductor devices. A first driving section may be connected to the pairs of unit buffer trays to adjust a first pitch between the pairs of unit buffer trays. A second driving section may be connected to the pairs of unit buffer trays to adjust a second pitch between first unit buffer trays and second unit buffer trays in the pairs.

In some example embodiments of the present invention, the first driving section may include a plurality of rack gears connected to the pairs of unit buffer trays, a gearbox comprising at least one output gear engaged with the rack gears, and a motor unit connected to the gearbox to provide a rotational force to the gearbox. The rack gears may be connected to at least one first pair and at least one second pair of unit buffer trays that are each disposed on both sides with respect to a central point of the buffer tray. Further, the rack gears may be engaged with the at least one output gear to move the first and the second pairs in opposite directions to each other.

In some example embodiments of the present invention, the gearbox may include a driving gear, a first pinion gear and a second pinion gear. The driving gear may be connected to a driving shaft of the motor unit. The first pinion gear may be connected to the driving shaft and may be engaged with a first rack gear and a second rack gear opposite to each other. Further, the first pinion gear may have a pitch circle smaller than that of the driving gear. The second pinion gear may be engaged with the driving gear to be rotated by the driving gear and may be engaged with a third rack gear and a fourth rack gear opposite to each other. Further, the second pinion gear may have a pitch circle smaller than that of the driving gear.

In some example embodiments of the present invention, the apparatus may further include a base plate on which the first and second driving sections are disposed.

In some example embodiments of the present invention, the rack gears and the gearbox may be disposed on an upper surface of the base plate. The motor unit may be disposed on a lower surface of the base plate. The motor unit may be connected to the gearbox through the base plate.

In some example embodiments of the present invention, the rack gears may be connected to the pairs of unit buffer trays by a plurality of supports. The supports may extend in a direction substantially perpendicular to a pitch direction of the buffer tray.

In some example embodiments of the present invention, the first driving section may include a plurality of rack gears, a gearbox comprising at least one output gear, and a motor unit connected to the gearbox to provide a rotational force to the gearbox. The rack gears may be connected to at least one first pair and at least one second pair of unit buffer trays that are each disposed on both sides with respect to a pair of unit buffer trays adjacent to a central point of the buffer tray. Further, the rack gears may be engaged with the at least one output gear to move the first and the second pairs in opposite directions to each other.

In some example embodiments of the present invention, the first driving section may include a plurality of rack gears, a gearbox comprising a plurality of output gears, and a motor unit connected to the gearbox to provide a rotational force to the gearbox. The rack gears may be connected to remaining pairs of unit buffer trays, except for an outermost pair of unit buffer trays, and may be engaged with the output gears to move the remaining pairs in a pitch direction of the buffer tray.

In some example embodiments of the present invention, the buffer tray may include two pairs of unit buffer trays, and the first driving section may include a rack gear connected to one of the two pairs to adjust the first pitch, a gearbox comprising an output gear engaged with the rack gear, and a motor unit connected to the gearbox to provide a rotational force to the gearbox.

In some example embodiments of the present invention, the apparatus may further include first links connected to the first unit buffer trays and second links connecting the second unit buffer trays with the first links. The first driving section may be connected to the first unit buffer trays or the second unit buffer trays.

In some example embodiments of the present invention, the first and second unit buffer trays may be connected to the first and second links by a plurality of supports that extend in a direction substantially perpendicular to a pitch direction of the buffer tray.

In some example embodiments of the present invention, the second driving section may be connected to the first links or the second links, and may apply a driving force to the first links or the second links to produce a relative movement between the first unit buffer trays and the second unit buffer trays.

In some example embodiments of the present invention, the apparatus may further include at least one guide member configured to guide the first unit buffer trays and the second unit buffer trays in a pitch direction of the buffer tray.

In some example embodiments of the present invention, the apparatus may further include a guide member extending in a pitch direction of the buffer tray. The guide member may be movably disposed in a direction substantially perpendicular to the pitch direction of the buffer tray by the second driving section and may guide connecting portions between the first links or the second links in the pitch direction of the buffer tray. Further, the apparatus may include second guide members connected to both side portions of the guide member to guide the guide member in the direction substantially perpendicular to the pitch direction of the buffer tray.

In an apparatus for adjusting a pitch of a buffer tray according to still another aspect of the present invention, the buffer tray may include a plurality of unit buffer trays for receiving semiconductor devices. The apparatus may include a motor unit generating a rotational force, a gearbox connected to the motor unit and comprising at least one output gear, and at least one rack gear connected to at least one of the unit buffer trays and the at least one output gear to adjust a pitch between the unit buffer trays.

In some example embodiments of the present invention, each of the unit buffer trays may have a plurality of sockets for receiving the semiconductor devices. The sockets may be arranged in at least one column substantially perpendicular to a pitch direction of the buffer tray, and the unit buffer trays may be arranged in the pitch direction of the buffer tray.

In some example embodiments of the present invention, the buffer tray may include even-numbered unit buffer trays. A plurality of rack gears may be connected to at least one first unit buffer tray and at least one second unit buffer tray that are each disposed on both sides with respect to a central point of the buffer tray, and may be engaged with the at least one output gear to move the first and second unit buffer trays in opposite directions to each other.

In some example embodiments of the present invention, the buffer tray may include odd-numbered unit buffer trays. A plurality of rack gears may be connected to at least one first unit buffer tray and at least one second unit buffer tray that are each disposed on both sides with respect to a central unit buffer tray, and may be engaged with the at least one output gear to move the first and second unit buffer trays in opposite directions to each other.

In some example embodiments of the present invention, the at least one rack gear may be connected to at least one remaining unit buffer tray, except for an outermost unit buffer tray, and may be engaged with the at least one output gear to move the at least one remaining unit buffer tray in a pitch direction of the buffer tray.

In accordance with the example embodiments of the present invention, a pitch of a buffer tray may be equalized with that of a test tray or a customer tray by a first driving section and a second driving section.

As a result, there is no need to adjust a pitch of a picker system while transferring the semiconductor devices, thereby shortening the time required to transfer the semiconductor devices. Further, there is no need for an additional device for adjusting the pitch of the picker system, and thus the weight of the picker system may be reduced, thereby improving the structural stability of the test handler.

### BRIEF DESCRIPTION OF THE DRAWINGS

Example embodiments of the present invention will become readily apparent along with the following detailed description when considered in conjunction with the accompanying drawings, wherein:

FIG. 1 is a perspective view illustrating an apparatus for adjusting a pitch of a buffer tray in accordance with a first example embodiment of the present invention;

FIG. 2 is a schematic plan view illustrating a buffer tray;

FIG. 3 is a schematic plan view illustrating a gearbox of the first driving section shown in FIG. 1;

FIG. 4 is a perspective view illustrating a gearbox of the first driving section shown in FIG. 1;

FIG. 5 is a bottom view illustrating a first motor unit of the first driving section shown in FIG. 1;

FIGS. 6 to 8 are schematic plan views illustrating an apparatus for adjusting a pitch of the buffer tray shown in FIG. 1;

FIG. 9 is a schematic plan view illustrating an apparatus for adjusting a pitch of a buffer tray in accordance with a second example embodiment of the present invention;

FIG. 10 is a schematic plan view illustrating an apparatus for adjusting a pitch of a buffer tray in accordance with a third example embodiment of the present invention;

FIG. 11 is a schematic view illustrating another example of a buffer tray;

FIG. 12 is a schematic plan view illustrating an apparatus for adjusting a pitch of a buffer tray in accordance with a fourth example embodiment of the present invention;

FIG. 13 is a schematic plan view illustrating an apparatus for adjusting a pitch of a buffer tray in accordance with a fifth example embodiment of the present invention; and

FIG. 14 is a schematic plan view illustrating an apparatus for adjusting a pitch of a buffer tray in accordance with a sixth example embodiment of the present invention.

### DESCRIPTION OF THE EMBODIMENTS

Embodiments of the invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first thin film could be termed a second thin film, and, similarly, a second thin film could be termed a first thin film without departing from the teachings of the disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompass both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Example embodiments of the present invention are described herein with reference to cross-section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

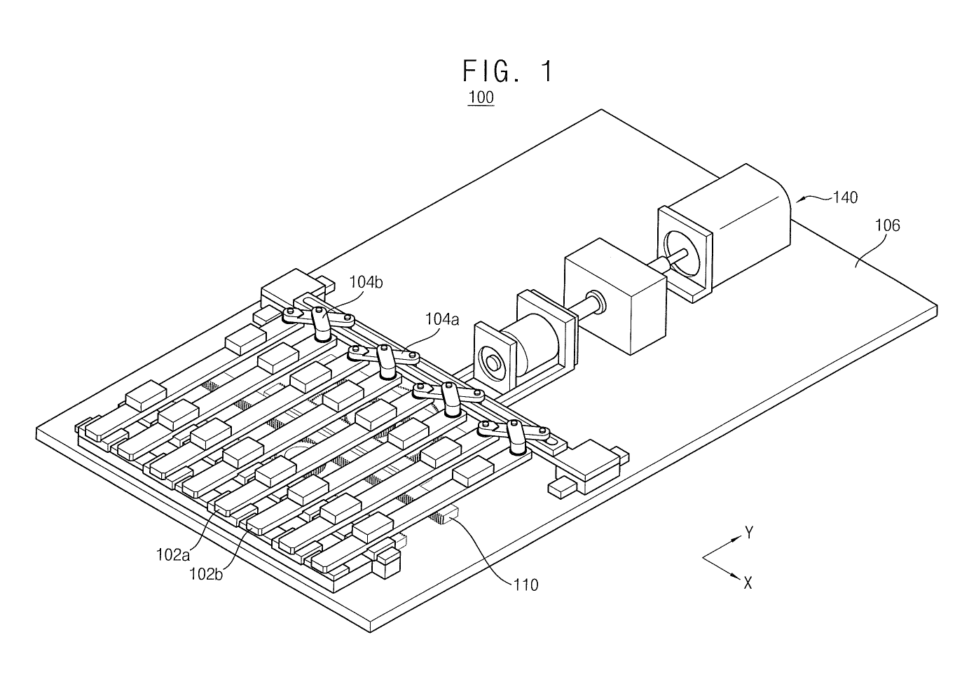

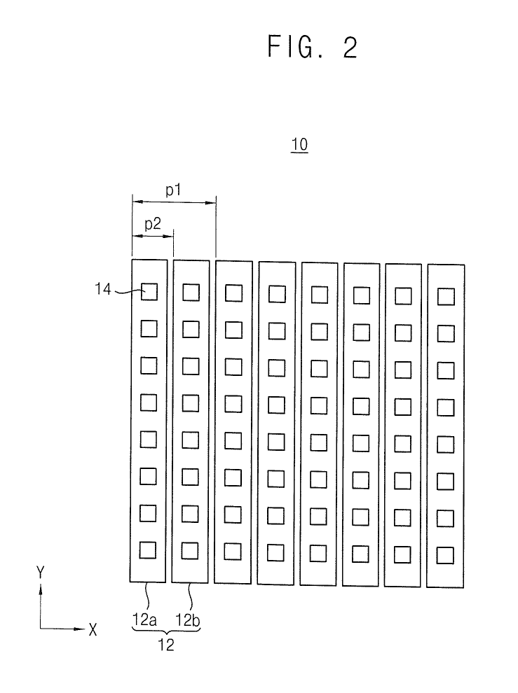

FIG. 1 is a perspective view illustrating an apparatus for adjusting a pitch of a buffer tray in accordance with a first example embodiment of the present invention, and FIG. 2 is a schematic plan view illustrating a buffer tray.

Referring to FIGS. 1 and 2, an apparatus 100 for adjusting a pitch of a buffer tray 10 according to a first example embodiment of the present invention may be employed in a test handler for testing semiconductor devices. Particularly, the apparatus 100 may be used for equalizing the pitch of the buffer tray 10 to that of a test tray (not shown) or a customer tray (not shown).

The buffer tray 10 may include a plurality of pairs of unit buffer trays 12. Each of the pairs of unit buffer trays may include a first unit buffer tray 12a and a second unit buffer tray 12b. For example, the buffer tray 10 may include four pairs 12 of unit buffer trays.

Each of the first and second unit buffer trays 12a and 12b may have a plurality of sockets 14 for receiving the semiconductor devices. The sockets 14 may arranged in one column. The first and second unit buffer trays 12a and 12b may be parallel to one another. For example, each of the first and second unit buffer trays 12a and 12b may have eight sockets 14 as shown in FIG. 2. However, the number of the sockets 14 of the first and second unit buffer trays 12a and 12b may vary as occasion demands. Here, the plurality of pairs of unit buffer trays 12 may be arranged in a row direction (x-axis direction) substantially perpendicular to a column direction (y-axis direction), that is, an extension direction of the first and second unit buffer trays 12a and 12b.

The first and second unit buffer trays 12a and 12b may each be disposed on first supports 102a and second supports 102b. The first and second supports 102a and 102b may extend in the column direction beneath the first and second unit buffer trays 12a and 12b.

First links 104a may be connected to end portions of the first supports 102a, and second links 104b may be connected to end portions of the second supports 102b. The second links 104b may be connected to the first links 104a. As shown in FIG. 1, the second links 104b may be connected to central portions of the first links 104a. Alternatively, end portions of the first links 104a and end portions of the second links 104b may be connected with each other. Further, the end portions of the first links 104a may be connected to central portions of the second links 104b.

The apparatus 100 may include a first driving section 110 and a second driving section 140 for adjusting a pitch in the row direction of the buffer tray 10. Particularly, the first driving section 110 may be used to adjust a first pitch p1 between the pairs of unit buffer trays 12. The second driving section 140 may be used to adjust a second pitch p2 between the first unit buffer trays 12a and the second unit buffer trays 12b. The first and second driving sections 110 and 140 may be disposed on a base plate 106.

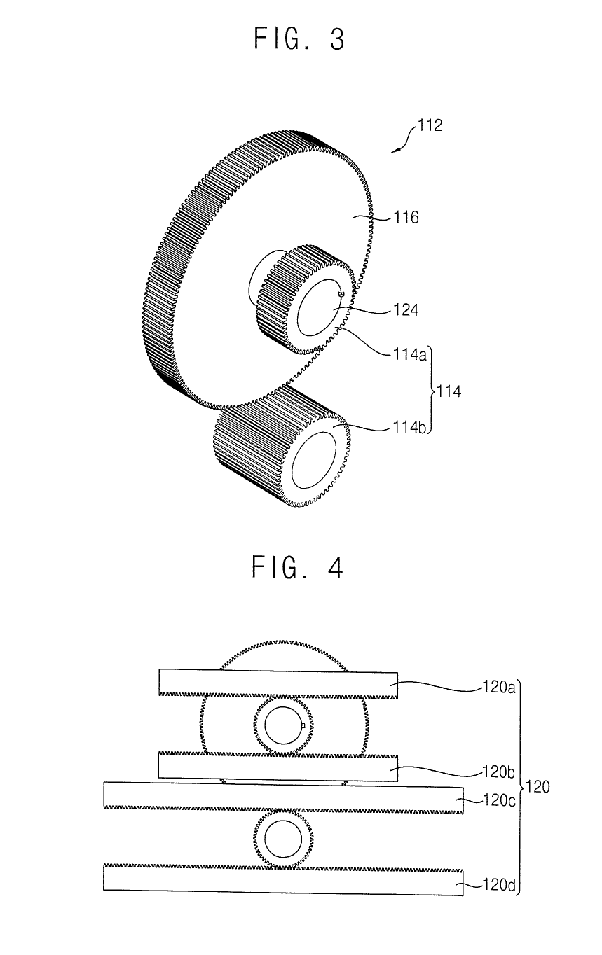

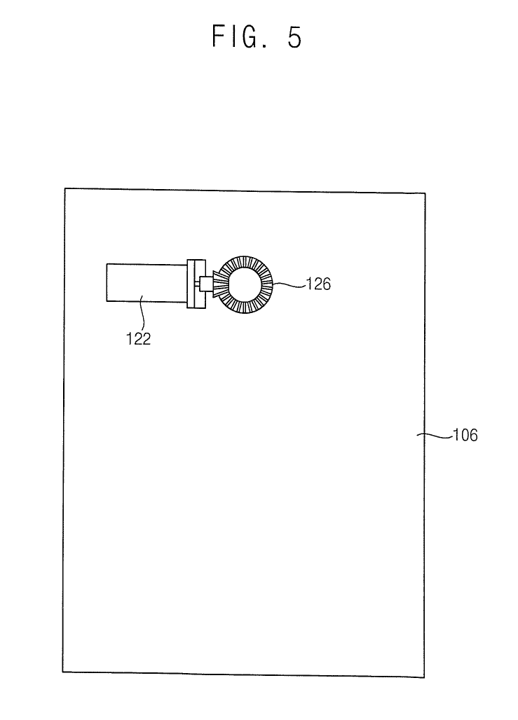

FIG. 3 is a schematic plan view illustrating a gearbox of the first driving section shown in FIG. 1, FIG. 4 is a perspective view illustrating a gearbox of the first driving section shown in FIG. 1, and FIG. 5 is a bottom view illustrating a first motor unit of the first driving section shown in FIG. 1.

Referring to FIGS. 3 to 5, the first driving section 110 may include a gearbox 112 including at least one output gear rotatably disposed on an upper surface of the base plate 106, a plurality of rack gears 120 engaged with the output gear, and a first motor unit 122 connected to the gearbox 112 to provide a rotational force to the gearbox 112.

For example, four rack gears 120 may be disposed on the upper surface of the base plate 106. The four rack gears 120 may be engaged with two pinion gears 114 serving as the output gears. Particularly, a first pinion gear 114a may be connected to a driving shaft 124 of the first motor unit 122, and may be further engaged with a first rack gear 120a and a second rack gear 120b opposite to each other. Further, a second pinion gear 114b may be engaged with a driving gear 116 that is connected to the driving shaft 124 of the first motor unit 122, and may be further engaged with a third rack gear 120c and a fourth rack gear 120d opposite to each other.

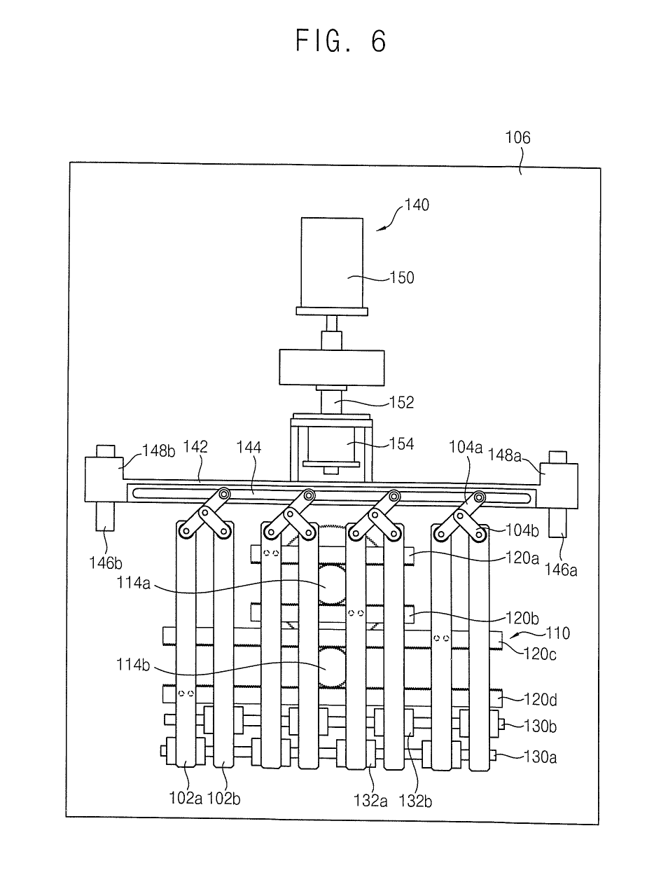

FIGS. 6 to 8 are schematic plan views illustrating an apparatus for adjusting a pitch of a buffer tray shown in FIG. 1.

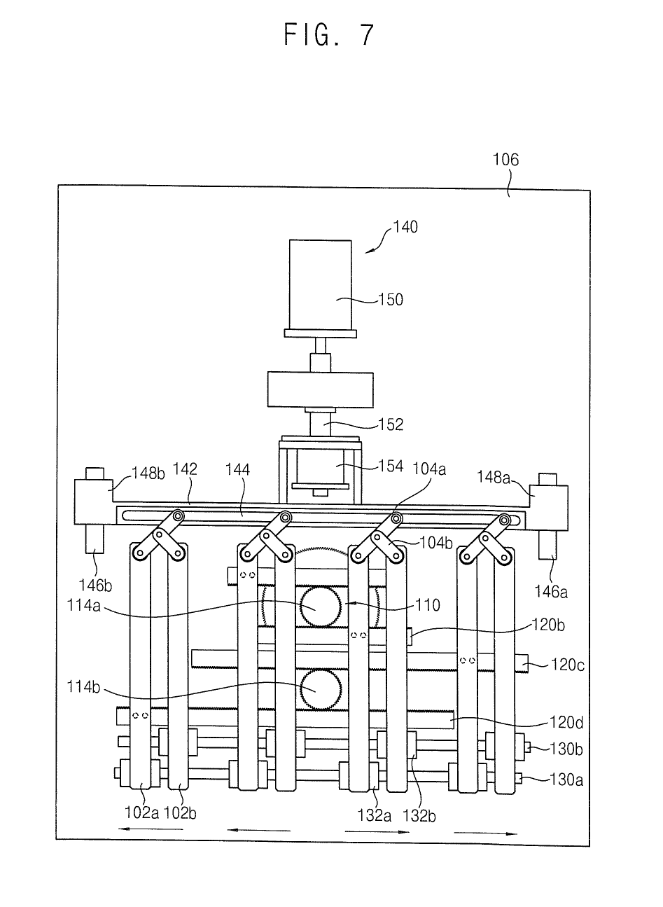

Referring to FIGS. 6 and 7, the first rack gear 120a and the second rack gear 120b may be connected to inner pairs of unit buffer trays 12 through the first and second supports 102a and 102b. The third rack gear 120c and the fourth rack gear 120d may be connected to outer pairs of unit buffer trays 12 through the first and second supports 102a and 102b. Particularly, first pairs of unit buffer trays 12 disposed on a left side of the buffer tray 10 in FIGS. 6 and 7 may be connected to the first and fourth rack gears 120a and 120d. Second pairs of unit buffer trays 12 disposed on a right side of the buffer tray 10 in FIGS. 6 and 7 may be connected to the second and third rack gears 120b and 120c. Thus, the first and second pairs of unit buffer trays 12 may be moved in opposite directions to each other with respect to a central point of the buffer tray 10 by rotating the first and second pinion gears 114a and 114b as shown in FIG. 7.

The first, second, third and fourth rack gears 120a, 120b, 120c and 120d may be connected to the first unit buffer trays 12a through the first supports 102a. Alternatively, the first, second, third and fourth rack gears 120a, 120b, 120c and 120d may be connected to the second unit buffer trays 12b through the second supports 102b.

Although not shown in the figures, a plurality of guide members may be disposed on the base plate 106 to guide the first, second, third and fourth rack gears 120a, 120b, 120c and 120d in the row direction of the buffer tray 10.

A ratio between rotational speeds of the first and second pinion gears 114a and 114b may be 1:3 so as to equalize intervals between the first unit buffer trays 12a with one another. Particularly, the first and second pinion gears 114a and 114b may have a pitch circle smaller than that of the driving gear 116. Particularly, the diameter of the driving gear 116 may be three times larger than that of the second pinion gear 114b, and the diameter of the first pinion gear 114a may be substantially the same as that of the second pinion gear 114b. As a result, the first pitch p1 between the pairs of unit buffer trays 12 may be adjusted by rotating the first and second pinion gears 114a and 114b.

Meanwhile, because the first unit buffer trays 12a are connected to the second unit buffer trays 12b by the first and second links 104a and 104b, the second pitch p2 between the first and second unit buffer trays 12a and 12b may be evenly maintained while adjusting the first pitch p1.

As described above, the gearbox 112 includes two pinion gears 114a and 114b. However, the gearbox 112 may include three or more pinion gears having different rotational speeds, and the first driving section 110 may include a plurality of rack gears engaged with the pinion gears. That is, the numbers of the pinion gears and the rack gears may vary according to the number of the first unit buffer trays 12a.

Further, when the buffer tray 10 includes two pairs of unit buffer trays 12, the first driving section 110 may include one pinion gear and two rack gears.

Referring to FIGS. 4 and 5, the driving shaft 124 may extend through the base plate 106, and the first motor unit 122 may be disposed on a lower surface of the base plate 106. The first motor unit 122 may be connected with the driving shaft 124 by bevel gears 126. Alternatively, the first motor unit 122 may be directly connected with the driving shaft 124.

Referring to FIG. 6, at least one guide member, which extend in the row direction, may be disposed on the upper surface of the base plate 106 to guide the first and second supports 102a and 102b in the row direction, that is, a pitch direction of the buffer tray 10. For example, a first guide rail 130a and a second guide rail 130b may be disposed on the base plate 106. The first and second guide rails 130a and 130b may extend in the row direction. The first and second supports 102a and 102b may be coupled to the first and second guide rails 130a and 130b by first ball blocks 132a and second ball blocks 132b. Alternatively, the first and second supports 102a and 102b may be guided by one guide rail in the row direction.

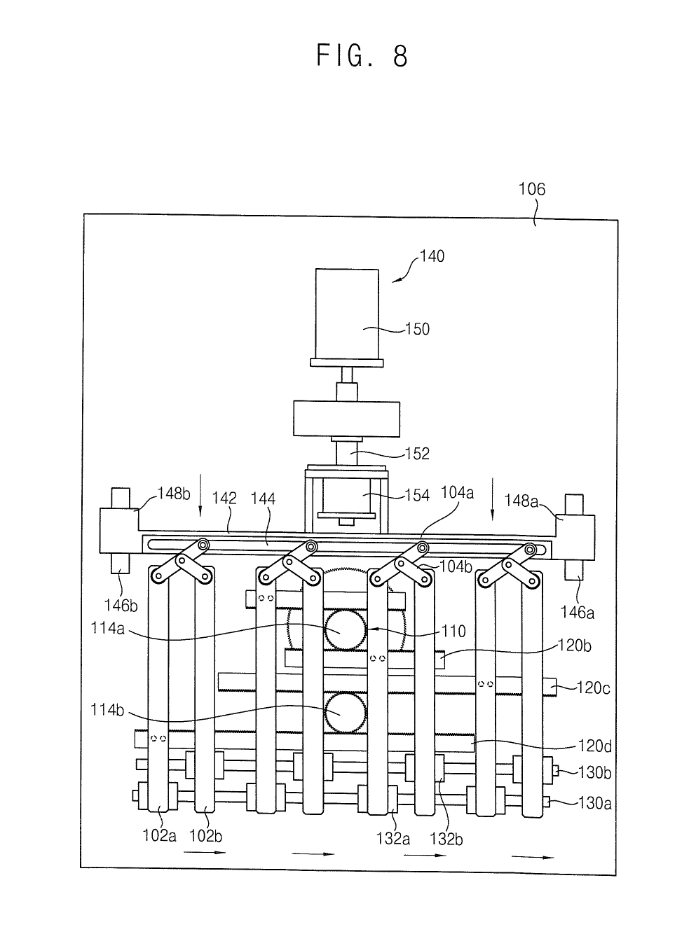

Referring to FIGS. 7 and 8, the second driving section 140 may be disposed on the upper surface of the base plate 106 and may be connected with end portions of the first links 104a. Particularly, the second driving section 140 may apply a driving force to the first links 104a to adjust the second pitch p2 between the first unit buffer trays 12a and the second unit buffer trays 12b. Thus, a relative movement may be produced between the first unit buffer trays 12a and the second unit buffer trays 12b.

The end portions of the first links 104a may be guided by a guide member in the row direction. For example, a guide bar 142 may be adjacent to the buffer tray 10, and may be extend in the row direction on the base plate 106. The guide bar 142 may have a slot 144 that extends in the row direction, and a plurality of rollers (not shown) may be disposed in the slot 144. The end portions of the first links 104a may be connected to the rollers.

Both side portions of the guide bar 142 may be coupled to a third guide rail 146a and a fourth guide rail 146b, which extend in the column direction on the base plate 106, through a third ball block 148a and a fourth ball block 148b. That is, the second driving section 140 may be connected to the end portions of the first links 104a through the guide bar 142 and the rollers. The guide bar 142 may be moved by the second driving section 140, and thus the first links 104a may rotate around axes located at the end portions of the first supports 102a, and the second links 104b may rotate around axes located at the central portions of the first links 104a. As a result, the second unit buffer trays 12b may be relatively moved in the row direction, that is, the pitch direction of the buffer tray 10, with respect to the first unit buffer trays 12a. The second pitch p2 of the buffer tray 10 may be adjusted by adjusting a moving distance of the guide bar 142.

As shown in FIGS. 6 to 8, after adjusting the first pitch p1, the second pitch p2 is adjusted. However, after adjusting the second pitch p2, the first pitch p1 may be adjusted according to circumstances.

Alternatively, the end portions of the first links 104a may be guided by a plurality of ball blocks and a guide rail in the row direction. For example, a fifth guide rail may be adjacent to the buffer tray 10, and a plurality of fifth ball blocks may be movably coupled to the fifth guide rail. The end portions of the first links 104a may be connected to the fifth ball blocks.

The second driving section 140 may be connected to the guide bar 142 on the upper surface of the base plate 106. Particularly, the second driving section 140 may include a second motor unit 150, a ball screw 152 connected with a rotation shaft of the second motor unit 150, and a ball nut 154 connected to the guide bar 142. The ball screw 152 may extend through the ball nut 154. A rotational force of the second motor unit 150 may be applied to the guide bar 142 through the ball screw 152 and the ball nut 154.

Alternatively, various types of reciprocating devices may be selectively used as the second driving section 140. For example, a reciprocating device including a cam and a spring, a pneumatic or hydraulic cylinder, etc. may be used as the second driving section 140.

Although not shown in the figures, the adjustment of the pitch of the buffer tray 10 may be inaccurately performed by the backlash of the first and second driving sections 110 and 140. To improve the accuracy in the adjustment of the pitch, the first unit buffer trays 12a and the second unit buffer trays 12b may be connected to one another by a plurality of springs. For example, the first unit buffer trays 12a and the second unit buffer trays 12b may be connected by first coil springs. Further, the first unit buffer trays 12a disposed on one side of the buffer tray 10 may be connected to each other by a second coil spring(s), and the first unit buffer trays 12a disposed on another side of the buffer tray 10 may be connected to each other by a third coil spring(s).

In accordance with the first example embodiment of the present invention, the first pitch p1 between the first unit buffer trays 12a may be adjusted by the first driving section 110, and the second pitch p2 between the first unit buffer trays 12a and the second unit buffer trays 12b may be adjusted by the second driving section 140. As a result, the pitch of the buffer tray 10 may be equalized to that of the test tray or the customer tray. Thus, there is no need to adjust a pitch of a picker system for transferring the semiconductor devices, thereby shortening the time required to transfer the semiconductor devices between the buffer tray and the test tray or the customer tray. Further, the weight of the picker system may be reduced, thereby improving the structural stability of the test handler and increasing the number of pickers of the picker system.

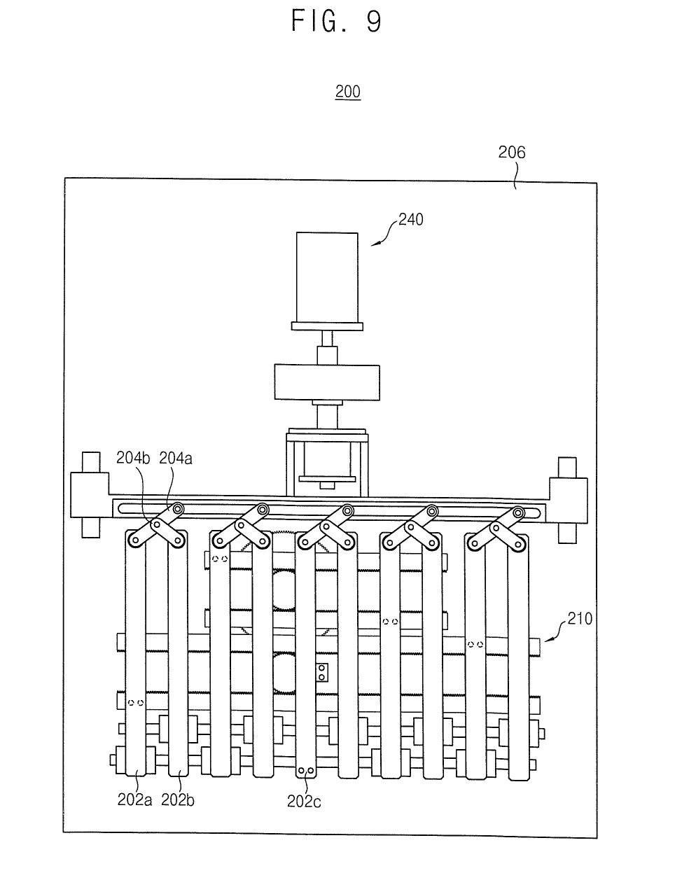

FIG. 9 is a schematic plan view illustrating an apparatus for adjusting a pitch of a buffer tray in accordance with a second example embodiment of the present invention.

Referring to FIG. 9, an apparatus 200 for adjusting a pitch of a buffer tray in accordance with a second example embodiment of the present invention may be employed in a test handler for testing semiconductor devices.

The buffer tray may include a plurality of pairs of unit buffer trays. Each of the pairs of unit buffer trays may include a first unit buffer tray and a second unit buffer tray. For example, the buffer tray may include five pairs of unit buffer trays. Further detailed descriptions for the pairs of unit buffer trays will be omitted because these elements are similar to those already described with reference to FIGS. 1 to 8.

The first and second unit buffer trays may each be disposed on first and second supports 202a and 202b. The first and second supports 202a and 202b may extend in a column direction of the buffer tray beneath the first and second unit buffer trays.

First links 204a may be connected to end portions of the first supports 202a. Second links 204b may be connected to end portions of the second supports 202b. The second links 204b may be connected with the first links 204a.

The apparatus 200 may include a first driving section 210 for adjusting a first pitch between the pairs of unit buffer trays and a second driving section 240 for adjusting a second pitch between the first unit buffer trays and the second unit buffer trays. The first driving section 210 may include at least one pinion gear and at least one rack gear. For example, the first driving section 210 may include two pinion gears and four rack gears. Further detailed descriptions for the first and second supports 202a and 202b, the first and second links 204a and 204b, and the first and second driving section 210 and 240 will be omitted because these elements are similar to those already described with reference to FIGS. 1 to 8.

Meanwhile, a central pair of unit buffer trays adjacent to a central point of the buffer tray may be fixed on an upper surface of a base plate 206, and remaining pairs of unit buffer trays, except for the central pair of unit buffer trays, may be connected to the first driving section 210. That is, a first support 202c connected to a first unit buffer tray of the central pair may be mounted on the base plate 206. For example, when the first unit buffer tray of the central pair is fixed on the base plate 206, the first driving section 210 may be connected to remaining first unit buffer trays. Alternatively, when a second unit buffer tray of the central pair is fixed on the base plate 206, the first driving section 210 may be connected to remaining second unit buffer trays.

As a result, the rack gears of the first driving section 210 may move the remaining pairs of unit buffer trays, which are disposed on both sides with respect to the central pair of unit buffer trays, in opposite directions to each other, thereby adjusting the first pitch between the pairs of unit buffer trays.

Particularly, a ratio between rotational speeds of a first pinion gear and a second pinion gear of the first driving section 210 may be 1:2 so as to equalize intervals between the first unit buffer trays with one another. As a result, the first pitch between the pairs of unit buffer trays may be adjusted.

Alternatively, when the buffer tray includes three pairs of unit buffer trays, the first driving section 210 may include one pinion gear and two rack gears.

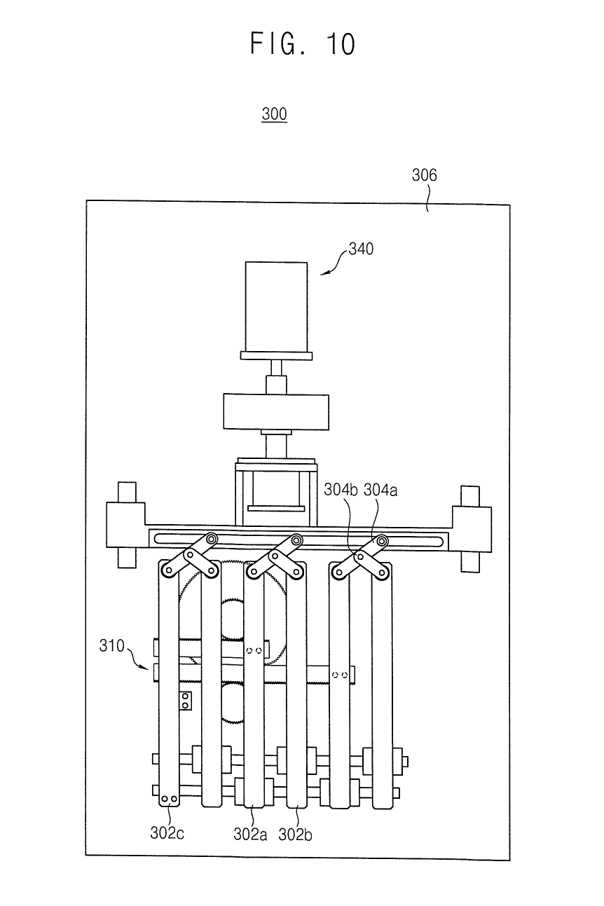

FIG. 10 is a schematic plan view illustrating an apparatus for adjusting a pitch of a buffer tray in accordance with a third example embodiment of the present invention.

Referring to FIG. 10, an apparatus 300 for adjusting a pitch of a buffer tray in accordance with a third example embodiment of the present invention may be employed in a test handler for testing semiconductor devices.

The buffer tray may include a plurality of pairs of unit buffer trays. Each of the pairs of unit buffer trays may include a first unit buffer tray and a second unit buffer tray. For example, the buffer tray may include three pairs of unit buffer trays. Further detailed descriptions for the pairs of unit buffer trays will be omitted because these elements are similar to those already described with reference to FIGS. 1 to 8.

The first and second unit buffer trays may each be disposed on first and second supports 302a and 302b. The first and second supports 302a and 302b may extend in a column direction of the buffer tray beneath the first and second unit buffer trays.

First links 304a may be connected to end portions of the first supports 302a. Second links 304b may be connected to end portions of the second supports 302b. The second links 304b may be connected with the first links 304a.

The apparatus 300 may include a first driving section 310 for adjusting a first pitch between the pairs of unit buffer trays and a second driving section 340 for adjusting a second pitch between the first unit buffer trays and the second unit buffer trays. The first driving section 310 may include at least one pinion gear and at least one rack gear. For example, the first driving section 310 may include two pinion gears and two rack gears. Further detailed descriptions for the first and second supports 302a and 302b, the first and second links 304a and 304b, and the first and second driving section 310 and 340 will be omitted because these elements are similar to those already described with reference to FIGS. 1 to 8.

Meanwhile, an outermost pair of unit buffer trays of the buffer tray may be fixed on an upper surface of a base plate 306, and remaining pairs of unit buffer trays may be connected to the first driving section 310. For example, when an outermost support 302c connected to a first unit buffer tray of the outermost pair is mounted on the base plate 306, the first driving section 310 may be connected to remaining first unit buffer trays. Alternatively, when a second unit buffer tray of the outermost pair is fixed on the base plate 306, the first driving section 310 may be connected to remaining second unit buffer trays.

As a result, the rack gears of the first driving section 310 may move the remaining pairs of unit buffer trays in a pitch direction of the buffer tray, thereby adjusting the first pitch between the pairs of unit buffer trays.

Particularly, a ratio between rotational speeds of a first pinion gear and a second pinion gear of the first driving section 310 may be 1:2 so as to equalize intervals between the first unit buffer trays with one another. As a result, the first pitch between the pairs of unit buffer trays may be adjusted.

Alternatively, when the buffer tray includes two pairs of unit buffer trays, the first driving section 310 may include one pinion gear and one rack gear.

FIG. 11 is a schematic view illustrating another example of a buffer tray.

In accordance with the first, second and third example embodiments of the present invention as described above, each of the first and second unit buffer trays 12a and 12b includes the plurality of sockets 14 arranged in one column. However, as shown in FIG. 11, a buffer tray 20 may include a plurality of unit buffer tray 22, and each of the unit buffer trays 22 may include a plurality of sockets 24a and 24b arranged in a plurality of columns. A pitch between the unit buffer trays having the plurality of columns may be adjusted by the apparatuses according to the first, second and third example embodiments of the present invention.

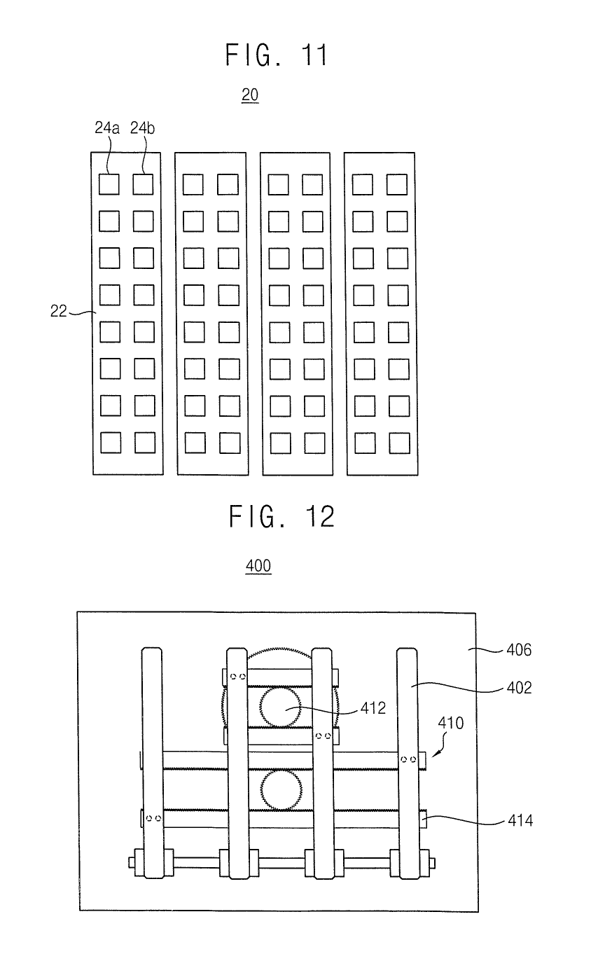

FIG. 12 is a schematic plan view illustrating an apparatus for adjusting a pitch of a buffer tray in accordance with a fourth example embodiment of the present invention.

Referring to FIG. 12, an apparatus 400 for adjusting a pitch of a buffer tray according to a fourth example embodiment of the present invention may be employed in a test handler for testing semiconductor devices.

The buffer tray may include a plurality of unit buffer trays. Each of the unit buffer trays may include a plurality of sockets arranged in a plurality of columns, for example, in two columns, as shown in FIG. 11. The buffer tray may include even-numbered unit buffer trays. For example, the buffer tray may include four unit buffer trays, and each of the unit buffer trays may include first sockets arranged in a column direction and second sockets arranged in parallel with the first sockets.

The apparatus 400 may include a driving section 410 connected to the unit buffer trays to adjust a pitch between the unit buffer trays in a row direction. The driving section 410 may include a gearbox including at least one output gear, a plurality of rack gears engaged with the output gear, and a motor unit for providing a rotational force. For example, the driving section 410 may adjust the pitch of the buffer tray using two pinion gears 412 serving as the output gears and four rack gears 414. Here, the unit buffer trays and the rack gears 414 may be connected to each other by supports 402 that are disposed on a base plate 406.

The driving section 410 may move the unit buffer trays, which are disposed on both sides with respect to a central point of the buffer tray, in opposite direction to each other so as to adjust the pitch of the buffer tray. Further descriptions for the driving section 410 will be omitted because the driving section 410 is similar to the first driving section 110 already described with reference to FIGS. 1 to 8.

The pitch of the buffer tray may be equalized to a pitch between odd-numbered columns of a test tray or a customer tray of the test handler by the apparatus 400. In such case, a picker system of the test handler picks up semiconductor devices using a plurality of pickers and then moves over the buffer tray. The picker system is aligned such that semiconductor devices held by pickers of odd-numbered columns are located over the first sockets of the buffer tray, and the semiconductor devices held by the pickers of odd-numbered columns are then received into the first sockets of the buffer tray. Further, after the picker system is aligned such that semiconductor devices held by pickers of even-numbered columns are located over the second sockets of the buffer tray, and the semiconductor devices held by the pickers of even-numbered columns are then received into the second sockets of the buffer tray.

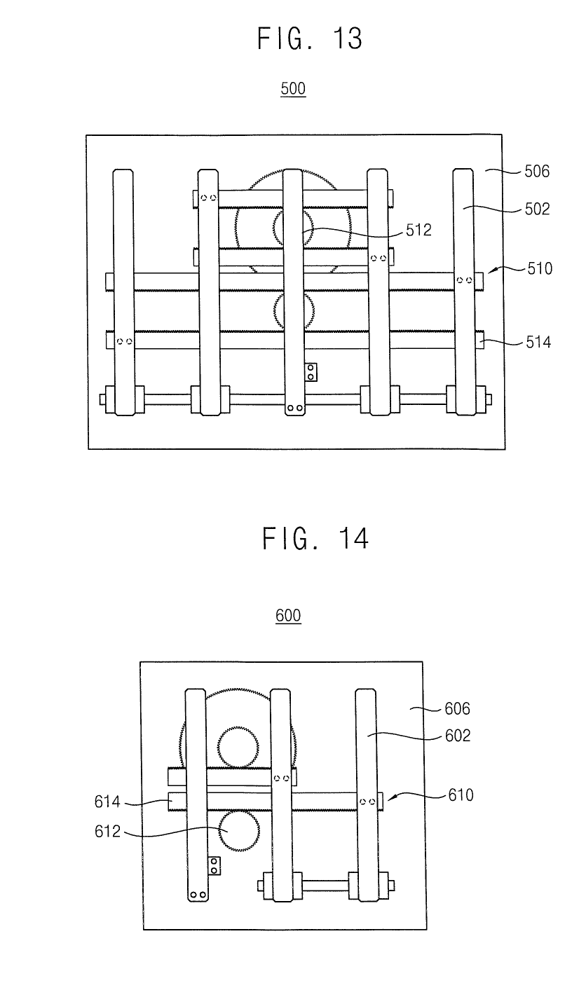

FIG. 13 is a schematic plan view illustrating an apparatus for adjusting a pitch of a buffer tray in accordance with a fifth example embodiment of the present invention.

Referring to FIG. 13, an apparatus 500 for adjusting a pitch of a buffer tray according to a fifth example embodiment of the present invention may be employed in a test handler for testing semiconductor devices.

The buffer tray may include a plurality of unit buffer trays. Each of the unit buffer trays may include a plurality of sockets arranged in a plurality of columns, for example, in two columns, as shown in FIG. 11. The buffer tray may include odd-numbered unit buffer trays. For example, the buffer tray may include five unit buffer trays, and each of the unit buffer trays may include first sockets arranged in a column direction and second sockets arranged in parallel with the first sockets.

The apparatus 500 may include a driving section 510 connected to the unit buffer trays to adjust a pitch between the unit buffer trays in a row direction. The driving section 510 may include a gearbox including at least one output gear, a plurality of rack gears engaged with the output gear, and a motor unit for providing a rotational force. For example, the driving section 510 may adjust the pitch of the buffer tray using two pinion gears 512 serving as the output gears and four rack gears 514. Here, the unit buffer trays and the rack gears 514 may be connected to each other by supports 502 that are disposed on a base plate 506.

The driving section 510 may move the unit buffer trays, which are disposed on both sides with respect to a central unit buffer tray of the buffer tray, in opposite direction to each other so as to adjust the pitch of the buffer tray. Further descriptions for the driving section 510 will be omitted because the driving section 510 is similar to the first driving section 210 already described with reference to FIG. 9.

FIG. 14 is a schematic plan view illustrating an apparatus for adjusting a pitch of a buffer tray in accordance with a sixth example embodiment of the present invention.

Referring to FIG. 14, an apparatus 600 for adjusting a pitch of a buffer tray according to a sixth example embodiment of the present invention may be employed in a test handier for testing semiconductor devices.

The buffer tray may include a plurality of unit buffer trays. Each of the unit buffer trays may include a plurality of sockets arranged in a plurality of columns, for example, in two columns, as shown in FIG. 11. For example, the buffer tray may include three unit buffer trays, and each of the unit buffer trays may include first sockets arranged in a column direction and second sockets arranged in parallel with the first sockets.

The apparatus 600 may include a driving section 610 connected to the unit buffer trays to adjust a pitch between the unit buffer trays in a row direction. The driving section 610 may include a gearbox including at least one output gear, at least one rack gear engaged with the at least one output gear, and a motor unit for providing a rotational force. For example, the driving section 610 may adjust the pitch of the buffer tray using two pinion gears 612 serving as the output gears and two rack gears 614. Here, the unit buffer trays and the rack gears 614 may be connected to each other by supports 602 that are disposed on a base plate 606.

The driving section 610 may move remaining unit buffer trays, except for an outermost unit buffer tray, in a pitch direction of the buffer tray to adjust the pitch of the buffer tray. Further descriptions for the driving section 610 will be omitted because the driving section 610 is similar to the first driving section 310 already described with reference to FIG. 10.

In accordance with the fourth, fifth and sixth example embodiments of the present invention, the unit buffer trays having the sockets arranged in the columns are used. Alternatively, the apparatuses according to the fourth, fifth and sixth example embodiments of the present invention may be used to adjust the pitch of the unit buffer trays having the sockets arranged in one column as shown in FIG. 2.

In accordance with the example embodiments of the present invention as described above, a pitch of a buffer tray may be adjusted by a first driving section including at least one pinion gear and at least one rack gear and a second driving section for moving links so that the pitch of the buffer tray may be equalized with that of a test tray or a customer tray.

Thus, there is no need to adjust a pitch of a picker system while transferring semiconductor devices, thereby shortening the time required to transfer the semiconductor devices. Further, there is no need for an additional device to adjust the pitch of the picker system, thereby reducing the weight of the picker system and improving the structural stability of a test handler.

Although the example embodiments of the present invention have been described, it is understood that the present invention should not be limited to these example embodiments but various changes and modifications can be made by those skilled in the art within the spirit and scope of the present invention as hereinafter claimed.

What is claimed is:

1. A method of adjusting a pitch of a buffer tray that comprises a plurality of pairs of unit buffer trays for receiving semiconductor devices, comprising:
adjusting a first pitch between the pairs of unit buffer trays; and
adjusting a second pitch between first unit buffer trays and second unit buffer trays in the pairs.

2. The method of claim 1, wherein the first pitch is adjusted by moving at least one first pair and at least one second pair of the unit buffer trays in opposite directions to each other, and wherein the first and second pairs are each disposed on both sides with respect to a central point of the buffer tray.

3. The method of claim 1, wherein the first pitch is adjusted by moving at least one first pair and at least one second pair of unit buffer trays in opposite directions to each other, and wherein the first and the second pairs are each disposed on both sides with respect to a pair of unit buffer trays adjacent to a central point of the buffer tray.

4. The method of claim 1, wherein the first pitch is adjusted by moving at least one remaining pair of unit buffer trays, except for an outermost pair of unit buffer trays, in a pitch direction of the buffer tray.

5. The method of claim 1, wherein the second pitch is adjusted by relatively moving the second unit buffer trays with respect to the first unit buffer trays.

6. An apparatus for adjusting a pitch of a buffer tray that comprises a plurality of pairs of unit buffer trays for receiving semiconductor devices, comprising:
a first driving section connected to the pairs of unit buffer trays to adjust a first pitch between the pairs of unit buffer trays; and
a second driving section connected to the pairs of unit buffer trays to adjust a second pitch between first unit buffer trays and second unit buffer trays in the pairs.

7. The apparatus of claim 6, wherein the first driving section comprises:
a plurality of rack gears connected to the pairs of unit buffer trays;
a gearbox comprising at least one output gear engaged with the rack gears; and
a motor unit connected to the gearbox to provide a rotational force to the gearbox,
wherein the rack gears are connected to at least one first pair and at least one second pair of unit buffer trays that are each disposed on both sides with respect to a central point of the buffer tray, and engaged with the at least one output gear to move the first and the second pairs in opposite directions to each other.

8. The apparatus of claim 7, wherein the gearbox comprises:
a driving gear connected to a driving shaft of the motor unit;
a first pinion gear connected to the driving shaft and engaged with a first rack gear and a second rack gear opposite to each other, the first pinion gear having a pitch circle smaller than that of the driving gear; and
a second pinion gear engaged with the driving gear to be rotated by the driving gear and engaged with a third rack gear and a fourth rack gear opposite to each other, the second pinion gear having a pitch circle smaller than that of the driving gear.

9. The apparatus of claim 7, comprising a base plate on which the first and second driving sections are disposed.

10. The apparatus of claim 9, wherein the rack gears and the gearbox are disposed on an upper surface of the base plate, the motor unit is disposed on a lower surface of the base plate, and the motor unit is connected to the gearbox through the base plate.

11. The apparatus of claim 7, wherein the rack gears are connected to the pairs of unit buffer trays by a plurality of supports that extend in a direction substantially perpendicular to a pitch direction of the buffer tray.

12. The apparatus of claim 6, wherein the first driving section comprises:
a plurality of rack gears;
a gearbox comprising at least one output gear; and
a motor unit connected to the gearbox to provide a rotational force to the gearbox,
wherein the rack gears connected to at least one first pair and at least one second pair of unit buffer trays that are each disposed on both sides with respect to a pair of unit buffer trays adjacent to a central point of the buffer tray, and engaged with the at least one output gear to move the first and the second pairs in opposite directions to each other.

13. The apparatus of claim 6, wherein the first driving section comprises:
a plurality of rack gears;
a gearbox comprising a plurality of output gears; and
a motor unit connected to the gearbox to provide a rotational force to the gearbox,
wherein the rack gears are connected to remaining pairs of unit buffer trays, except for an outermost pair of unit buffer trays, and engaged with the output gears to move the remaining pairs in a pitch direction of the buffer tray.

14. The apparatus of claim 6, wherein the buffer tray comprises two pairs of unit buffer trays,
and wherein the first driving section comprises:
a rack gear connected to one of the two pairs to adjust the first pitch;
a gearbox comprising an output gear engaged with the rack gear; and
a motor unit connected to the gearbox to provide a rotational force to the gearbox.

15. The apparatus of claim 6, further comprising:
first links connected to the first unit buffer trays; and
second links connecting the second unit buffer trays with the first links,
wherein the first driving section is connected to the first unit buffer trays or the second unit buffer trays.

16. The apparatus of claim 15, wherein the first and second unit buffer trays are connected to the first and second links by a plurality of supports that extend in a direction substantially perpendicular to a pitch direction of the buffer tray.

17. The apparatus of claim 15, wherein the second driving section is connected to the first links or the second links, and applies a driving force to the first links or the second links to produce a relative movement between the first unit buffer trays and the second unit buffer trays.

18. The apparatus of claim 17, further comprising at least one guide member configured to guide the first unit buffer trays and the second unit buffer trays in a pitch direction of the buffer tray.

19. The apparatus of claim 17, further comprising a guide member extending in a pitch direction of the buffer tray, wherein the guide member is movably disposed in a direction substantially perpendicular to the pitch direction of the buffer tray by the second driving section and guides connecting portions between the first links or the second links in the pitch direction of the buffer tray.

20. The apparatus of claim 19, further comprising second guide members connected to both side portions of the guide member to guide the guide member in the direction substantially perpendicular to the pitch direction of the buffer tray.

21. An apparatus for adjusting a pitch of a buffer tray that comprises a plurality of unit buffer trays for receiving semiconductor devices, comprising:
a motor unit generating a rotational force;
a gearbox connected to the motor unit and comprising at least one output gear; and
at least one rack gear connected to at least one of the unit buffer trays and the at least one output gear to adjust a pitch between the unit buffer trays.

22. The apparatus of claim 21, wherein each of the unit buffer trays has a plurality of sockets for receiving the semiconductor devices, wherein the sockets are arranged in at least one column substantially perpendicular to a pitch direction of the buffer tray, and the unit buffer trays are arranged in the pitch direction of the buffer tray.

23. The apparatus of claim 21, wherein the buffer tray comprises even-numbered unit buffer trays, and wherein a plurality of rack gears is connected to at least one first unit buffer tray and at least one second unit buffer tray that are each disposed on both sides with respect to a central point of the buffer tray, and engaged with the at least one output gear to move the first and second unit buffer trays in opposite directions to each other.

24. The apparatus of claim 21, wherein the buffer tray comprises odd-numbered unit buffer trays, and wherein a plurality of rack gears is connected to at least one first unit buffer tray and at least one second unit buffer tray that are each disposed on both sides with respect to a central unit buffer tray, and engaged with the at least one output gear to move the first and second unit buffer trays in opposite directions to each other.

25. The apparatus of claim 21, wherein the at least one rack gear is connected to at least one remaining unit buffer tray, except for an outermost unit buffer tray, and engaged with the at least one output gear to move the at least one remaining unit buffer tray in a pitch direction of the buffer tray.
